(19) United States
(12) Patent Application Publication
(10) Pub. No.: US 2026/0070578 A1
(43) Pub. Date: Mar. 12, 2026

(54) Training Data Selection Device and Method

(71) Applicants: Hyundai Motor Company, Seoul (KR); Kia Corporation, Seoul (KR)

(72) Inventor: Hyeong Gyu Kim, Hwaseong-Si (KR)

(21) Appl. No.: 19/053,829

(22) Filed: Feb. 14, 2025

(30) Foreign Application Priority Data
Sep. 11, 2024 (KR) 10-2024-0123776

(51) Int. Cl. B60W 60/00; G06N 20/00; G06V 20/58

(52) U.S. Cl. CPC B60W 60/001; G06N 20/00; G06V 20/58

(57) ABSTRACT

An apparatus includes a processor, a communication circuit configured to perform communication with a training server, and a memory storing instructions. When executed by the processor, the instructions may cause the apparatus to obtain a first score by determining consistency of a bounding box of an object detected in an image and within a threshold distance from the vehicle, based on position and dimension information of the object, and to obtain a second score by determining class entropy of the object based on class probability information of the object. The apparatus may store the image and corresponding meta information in a database based on at least one of the first score being less than a predetermined first threshold value or the second score exceeding a predetermined second threshold value, transmit the stored image and meta information to the training server, receive updated information, output a signal, and control autonomous driving.

### CROSS-REFERENCE TO RELATED APPLICATION

This application claims the benefit of priority to Korean Patent Application No. 10-2024-0123776, filed in the Korean Intellectual Property Office on Sep. 11, 2024, the disclosure of which is incorporated herein by reference in its entirety.

### TECHNICAL FIELD

One example of the present disclosure relates to a training data selection device and method, and more specifically, to a device and method in which training data may be selected from images acquired from a vehicle.

### BACKGROUND

The matters described in this Background section are only for enhancement of understanding of the background of the disclosure, and should not be taken as acknowledgment that they correspond to prior art already known to those skilled in the art.

Active learning may be a method of which the inference performance of a network is gradually improved by repeatedly performing the process of selecting and labeling data that is useful for training from a randomly collected training dataset, and then performing training on the selected and labeled data.

An example of active learning methods may include a method of selecting data that is useful for training by numerically modeling the inference uncertainty of a deep learning model. This method may reduce the cost required for data labeling because the same inference performance may be expected with a smaller dataset.

However, the active learning methods may not be able to determine what the confused class is because they only use numerical values for probability distributions, not specific classes. In addition, the active learning methods may not be applied to information that is not output in the form of the probability distribution.

### SUMMARY

According to the present disclosure, an apparatus for controlling autonomous driving of a vehicle, the apparatus may comprise a processor, a communication circuit configured to perform communication with a training server, a memory storing instructions that, when executed by the processor, are configured to cause the apparatus to obtain a first score by determining consistency of a bounding box of an object, wherein the object is detected in an image and is within a threshold distance from the vehicle, and wherein the determining the consistency is based on position and dimension information of the object, obtain a second score by determining class entropy of the object based on class probability information of the object, store the image and corresponding meta information in a database based on at least one of the first score being less than a predetermined first threshold value, or the second score exceeding a predetermined second threshold value, transmit, via the communication circuit, the stored image and corresponding meta information to the training server, receive updated information from the training server based on the stored image and corresponding meta information, output, based on the updated information, a signal, and control, based on the signal, autonomous driving of the vehicle.

The instructions, when executed by the processor, are further configured to cause the apparatus to alternately select a first image with a lowest first score and a second image with a highest second score, wherein the lowest first score is a lowest score among first scores associated with consistency of the bounding box, and wherein the highest second score is a highest score among second scores associated with class entropy of the object, and transmit the selected first and second images to the training server along with the corresponding meta information.

The instructions, when executed by the processor, are further configured to cause the apparatus to skip an image that has already been selected during the alternate selection and proceed with a next selection process. The alternate selection is performed as many times as a predetermined threshold number.

The instructions, when executed by the processor, are further configured to cause the apparatus to delete images stored in the database based on the images being selected as many as the predetermined threshold number and transmitted to the training server.

The instructions, when executed by the processor, are further configured to cause the apparatus to receive, from the training server, target class information, the predetermined first threshold value, and the predetermined second threshold value.

The corresponding meta information may comprise the position and dimension information of the object, the first score, the class probability information of the object, and the second score.

The instructions, when executed by the processor, are further configured to cause the apparatus to obtain the first score based on consistency among dimension vectors included in the bounding box.

The instructions, when executed by the processor, are further configured to cause the apparatus to obtain the second score based on contribution of each class to class inference uncertainty at a specific position in the image.

The instructions, when executed by the processor, are further configured to cause the apparatus to store, in the database and based on receiving an image storage trigger signal, an image and meta information associated with the image, wherein the image is captured during a time period associated with the image storage trigger signal.

According to the present disclosure, a method performed by an apparatus for controlling autonomous driving of a vehicle, the method may comprise determining position and dimension information of an object detected in an image, wherein the object is within a threshold distance from the vehicle, obtaining a first score by determining consistency of a bounding box of the object based on the position and dimension information of the object, determining class probability information of the object, obtaining a second score by determining class entropy of the object based on the class probability information of the object, storing the image and corresponding meta information in a database based on at least one of the first score being less than a predetermined first threshold value, or the second score exceeding a predetermined second threshold value, transmitting, via a communication circuit of the vehicle, the stored image and corresponding meta information to a training server, receiving updated information from the training server based on the stored image and corresponding meta information, outputting, based on the updated information, a signal, and controlling, based on the signal, autonomous driving of the vehicle.

The transmitting the stored image and corresponding meta information may comprise alternately selecting a first image with a lowest first score and a second image with a highest second score, wherein the lowest first score is a lowest score among first scores associated with consistency of the bounding box, and wherein the highest second score is a highest score among second scores associated with class entropy of the object, and transmitting the selected first and second images to the training server along with the corresponding meta information.

The transmitting the stored image and corresponding meta information may comprise skipping an image that has already been selected during the alternately selecting and proceeding with a next data selection process.

The transmitting the stored image and corresponding meta information may comprise performing the alternately selecting as many times as a predetermined threshold number, and transmitting the selected first and second images along with the corresponding meta information to the training server. The method may further comprise deleting images stored in the database based on the images being selected as many as the predetermined threshold number and transmitted to the training server.

The method may further comprise before the determining the position and dimension information of the object, receiving, from the training server and via the communication circuit, target class information, the predetermined first threshold value, and the predetermined second threshold value.

The method may further comprise causing the training server to perform a training process based on the image and corresponding meta information received via the communication circuit as training data, determining, based on the training data, target class information, the predetermined first threshold value, and the predetermined second threshold value, and transmitting the target class information, the first predetermined threshold value, and the predetermined second threshold value to the vehicle via the communication circuit.

The obtaining the first score may comprise obtaining the first score based on consistency among dimension vectors included in the bounding box. The obtaining the second score may comprise obtaining the second score based on contribution of each class to class inference uncertainty at a specific position in the image.

The method may further comprise storing, in the database and based on receiving an image storage trigger signal, an image and meta information associated with the image, wherein the image is captured during a time period associated with the image storage trigger signal.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example of a vehicle according to an example;

FIG. 2 shows an example of a training data selection device according to an example;

FIG. 3 shows an example of an operation of a training data selection device according to an example;

FIG. 4, FIG. 5, and FIG. 6 show an example of an operation of a processor according to an example;

FIG. 7 shows an example of the operation of a first processing unit 121 according to an example;

FIG. 8 shows an example of the operation of a fourth processing unit 124 according to an example;

FIG. 9 shows an example of a training data selection method according to an example;

FIG. 10 shows an example of a training data selection method according to an example; and

FIG. 11 shows an example of a training data selection method according to an example.

### DETAILED DESCRIPTION

Hereinafter, preferred examples of the present disclosure will be described in detail with reference to the attached drawings.

However, the technical idea of the present disclosure is not limited to some of the examples described, but may be implemented in various different forms, and within the scope of the technical idea of the present disclosure, one or more of the components among the examples may be selectively combined or substituted for use.

In addition, terms (including technical and scientific terms) used in the examples of the present disclosure may be interpreted as having a meaning that may be generally understood by a person of ordinary skill in the technical field to which the present disclosure belongs, unless explicitly and specifically defined and described, and terms that are commonly used, such as terms defined in a dictionary, may be interpreted in consideration of the contextual meaning of the relevant technology.

Additionally, the terms used in the examples of the present disclosure are for the purpose of describing the examples and are not intended to limit the present disclosure.

In this specification, the singular may also include the plural unless specifically stated otherwise in the phrase, and when it is described as “at least one (or more) of A, B, and/or C,” it may include one or more of all combinations that may be combined with A, B, C.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, when describing components of examples of the present disclosure, terms such as first, second, A, B, (a), (b), etc., may be used.

These terms are only intended to distinguish the components from other components, and are not intended to limit the nature, order, or sequence of the components.

And, when a component is described as being ‘connected’, ‘coupled’, or ‘connected’ to another component, it may include not only cases where the component is ‘connected’, ‘coupled’, or ‘connected’ directly to the other component, but also cases where the component is ‘connected’, ‘coupled’, or ‘connected’ by another component between the component and the other component.

In addition, when described as being formed or arranged “above” or “below” each component, “above” or “below” includes not only the case where the two components are in direct contact with each other, but also the case where one or more other components are formed or arranged between the two components. In addition, when expressed as “above” or “below,” the meaning of the downward direction as well as the upward direction based on one component may be included.

Hereinafter, examples will be described in detail with reference to the attached drawings. Regardless of the drawing symbols, identical or corresponding components are given the same reference numerals and redundant descriptions thereof will be omitted.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of bounding box consistency and class entropy of an object associated with the bounding box) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of bounding box consistency and class entropy of an object associated with the bounding box) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of bounding box consistency and class entropy of an object associated with the bounding box) described herein.

Minimum risk maneuver (MRM) operation(s) may also be controlled, for example, based on one or more features (e.g., features of bounding box consistency and class entropy of an object associated with the bounding box) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of bounding box consistency and class entropy of an object associated with the bounding box) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of bounding box consistency and class entropy of an object associated with the bounding box) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

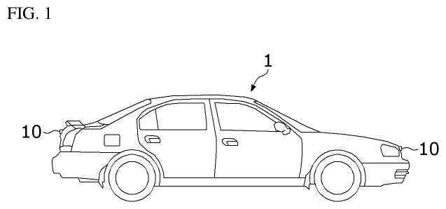

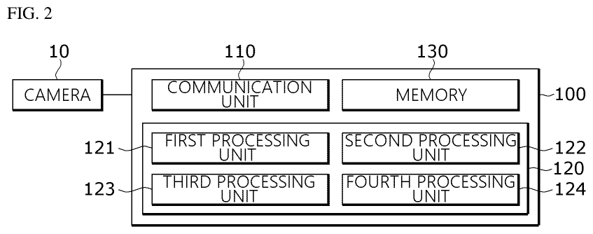

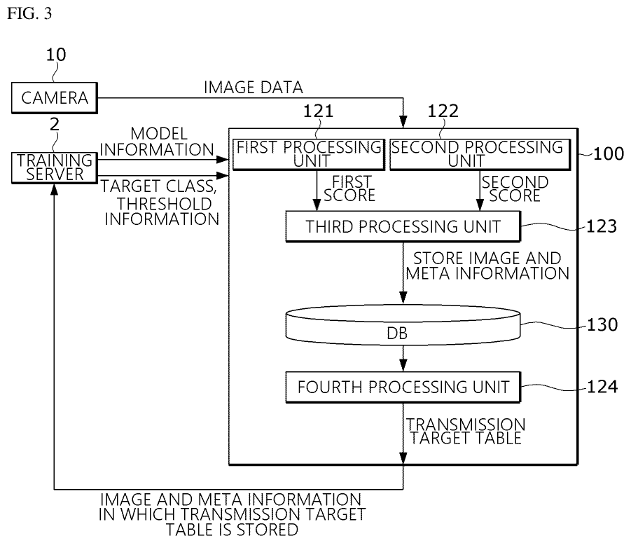

FIG. 1 shows an example of a vehicle according to an example, FIG. 2 shows an example of a training data selection device according to an example, and FIG. 3 shows an example of the operation of a training data selection device according to an example.

Referring to FIGS. 1 to 3, in an example, each component may have different functions and capabilities other than those described below, and may include additional components other than those described below. In addition, in an example, each component may be implemented using one or more physically separate devices, or may be implemented by one or more processors, or a combination of one or more processors and software, and may not be clearly distinguished in specific operations, unlike the illustrated example.

In the example, a training data selection device 100 may be configured to be integrated into a vehicle 1 or may be implemented as a separate device and mounted on the vehicle.

The training data selection device 100 according to the example may be implemented in a logic circuit by hardware, firmware, software, or a combination thereof, and may also be implemented using a general-purpose or special-purpose computer. The device may be implemented using a hardwired device, a field programmable gate array (FPGA), an application specific integrated circuit (ASIC), etc. In addition, the device 100 may be implemented as a system on chip (SoC) including one or more processors and controllers.

In addition, the training data selection device 100 may be installed in a computing device or server equipped with hardware elements in the form of software, hardware, or a combination thereof. The computing device or server may mean various devices including all or some of a communication device such as a communication modem for performing communication with various devices or wired/wireless communication networks, a memory for storing data for executing a program, and a microprocessor for executing a program and performing calculations and commands.

The vehicle 1 may be provided with a camera 10 that captures the external environment of the vehicle and generates image data.

The camera 10 mounted on the vehicle 1 is a module for capturing images of the front, rear, left, and right sides of the vehicle, and includes a front camera, a rear camera, a left-side camera, and a right-side camera.

The camera 10 may include an image sensor and an image processing module, and the image sensor may include at least one of a CMOS and a CCD.

The training data selection device 100 may include a communication unit 110, a processor 120, and a memory 130.

In addition, the processor 120 according to the example may include a first processing unit 121, a second processing unit 122, a third processing unit 123, and a fourth processing unit 124.

The communication unit 110 may support the training data selection device 100 to communicate with an electronic control unit (ECU) and sensors mounted on the vehicle 1. The communication unit 110 may include a transceiver that transmits and receives may messages using a controller area network (CAN) protocol. The communication unit 110 may include a wireless communication circuit and/or a wired communication circuit.

The communication unit 110 may communicate with a camera 10 mounted on the vehicle 1 and receive image data of the camera 10.

In addition, the communication unit 110 may communicate with a training server 2. The communication unit 110 may receive information configuring a learning model from the training server 2. In addition, the communication unit 110 may transmit images and meta information to the training server 2, or receive target class information, a first threshold value, a second threshold value, etc., from the training server 2.

The memory 130 may be a non-transitory storage medium that stores instructions executed by the first processing unit 121 to the fourth processing unit 124. The memory 130 may include at least one of storage media such as random access memory (RAM), static random access memory (SRAM), read only memory (ROM), programmable read only memory (PROM), electrically erasable and programmable ROM (EEPROM), erasable and programmable ROM (EPROM), a hard disk drive (HDD), a solid state disk (SSD), an embedded multimedia card (eMMC), a universal flash storage (UFS), and/or web storage.

In addition, the memory 130 may store data required for the operation of the processor 120 and perform a database function that stores result data output according to the operation of the processor 120.

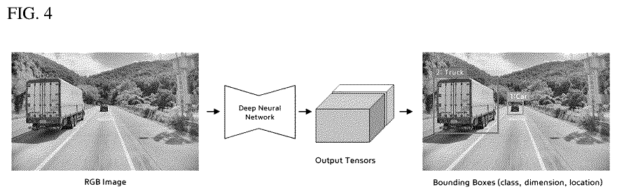

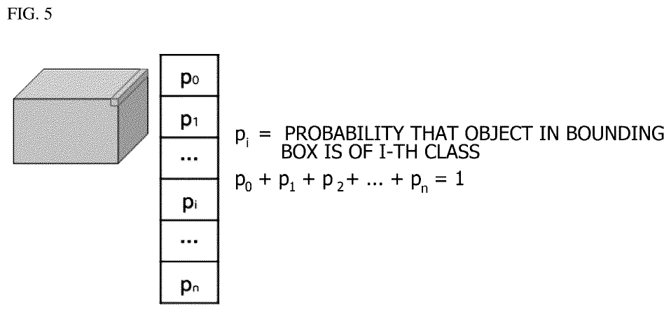

FIGS. 4 to 6 show an example of the operation of a processor according to an example. Referring to FIGS. 4 to 6, the processor 120 may detect an object in an image of the surroundings of a vehicle captured by a camera 10 and generate a bounding box. In an example, the bounding box is an object detection task element, and may mean a method of expressing the position and size of an object in an image or video frame as a rectangular box. The bounding box may generally be defined by four coordinates, and these coordinates may mean a minimum rectangular area surrounding an object.

The bounding box is expressed as a coordinate system where the upper left corner is the origin (0,0), the x-axis coordinates increase to the right, and the y-axis coordinates increase downward. The horizontal length of the bounding box may be defined as w and the vertical length as h. The bounding box roughly surrounds an object and may be used in an initial step for generating a more precise mask.

The processor 120 may predict whether an object exists in the image and represent the position of each object as a bounding box. For example, a COCO dataset may include the bounding box and class label of various objects in an image.

The processor 120 may use the bounding box in a task of tracking the movement of an object in a video sequence. The processor 120 may represent the position of the object as the bounding box for each image frame and track the movement path of the object.

For example, the processor 120 may evaluate the accuracy of the bounding box using intersection over union (IoU).

The IoU is an index that evaluates the degree of overlap between bounding boxes, and represents a ratio of the overlapping area between the predicted bounding box and the actual bounding box. The closer the IoU value is to 1, the more the two bounding boxes overlap.

For example, the processor 120 may evaluate the performance of object detection using precision, recall, and F1 score. The processor 120 may evaluate the performance of object detection by calculating true positive, false positive, and false negative at a specific IoU threshold value to derive the precision, recall, and F1 score.

The processor 120 may draw and label the bounding box of the object on the image to generate the bounding box. LabelImg, VoTT, etc., may be utilized as a labeling tool.

For example, the processor 120 may divide the image into candidate regions (region proposal) of various sizes and ratios using region-based convolutional neural networks (R-CNN), and detect the object using CNN for each region.

For example, the processor 120 may divide the image into grid cells using you only look once (YOLO), and predict the bounding box and class probability for each grid cell. The processor 120 may analyze the class of the object included in the bounding box by probability and calculate the probability for each class. At this time, the sum of all class probabilities may be 1.

For example, the processor 120 may predict bounding boxes with various sizes and ratios at once using a single shot multi-box detector (SSD).

The bounding box plays an important role in deep learning-based object detection and tracking tasks, and is used to define the position and size of the object. Since the accuracy of the bounding box has a significant impact on the performance of the model, it is important to improve the model through appropriate evaluation indicators and learning methods.

The first processing unit 121 may calculate a first score by evaluating the bounding box consistency of the object using the position and dimension information of the object detected in the image of the surroundings of the vehicle. The bounding box consistency may refer to how well a predicted bounding box aligns with the actual object it represents in terms of position, size, and reliability. It may evaluate several key aspects, including positional accuracy, dimension stability, and prediction confidence. Positional consistency ensures that the bounding box accurately encloses the object at the correct location, for example, measured using metrics like Intersection over Union (IoU), which determines the overlap between the predicted bounding box and the ground truth. Dimension consistency may examine whether the width and height of the bounding box are appropriate for the object's size, avoiding under or overestimation. The bounding box consistency may be used as a score to filter out unreliable detections, ensuring only high-quality data is included in training or evaluation, particularly for applications like autonomous driving of a vehicle.

The first processing unit 121 may calculate the first score using the consistency between dimension vectors included in the bounding box.

The bounding box consistency is an important concept in object detection issues, and corresponds to a method for evaluating how much the bounding box predicted by the deep learning model matches the boundary of the actual object.

The first processing unit 121 may calculate the bounding box consistency by comparing the consistency of the dimension vectors included in the remaining bounding box range after removing duplicate bounding boxes using a post-processing technique such as non-maximum suppression (NMS). In an example, the dimension vectors may mean four coordinates (x-coordinate of the box, y-coordinate of the box, horizontal length w of the box, and vertical length h of the box) that define the bounding box.

For example, the first processing unit 121 may measure the consistency between two bounding boxes (predicted value and actual value) by applying the IoU method. The IoU is an index for evaluating the degree of overlap between bounding boxes, and represents the ratio of the overlapping area between the predicted bounding box and the actual bounding box. The first processing unit 121 may determine that the closer the IoU value is to 1, the more the two bounding boxes overlap.

For example, the first processing unit 121 may measure a distance between the centroids of the predicted bounding box and the actual bounding box by applying a center distance method. The first processing unit 121 may determine that the smaller the distance between the centroids of the predicted bounding box and the actual bounding box, the more the two bounding boxes match.

For example, the first processing unit 121 may measure how similar the aspect ratios of the bounding boxes are by applying the aspect ratio similarity method. The first processing unit 121 may determine that the more similar the aspect ratios of the bounding boxes are, the more consistent the shapes of the bounding boxes are.

In the case of an anchor-based model, the first processing unit 121 may calculate the first score by analyzing the consistency of the dimension vectors included in the finally selected bounding range.

Alternatively, in the case of an anchor-free model, the first processing unit 121 may calculate the first score by analyzing the consistency of the dimension vectors of the bounding boxes whose centroids are within the range of the final bounding box among the inferred bounding boxes.

Alternatively, in the case of a 3D object detection model, the first processing unit 121 may calculate the first score by analyzing the IoU between a finally selected cuboid and a cuboid included within the range.

The anchor-free model and the anchor-based model are two approaches used in the field of object detection. The anchor-based model detects objects at each position of an image using multiple anchor boxes with predefined sizes and ratios. These anchor boxes are set to have various sizes and ratios, and each anchor box may be adjusted by a network to determine whether it is likely for each anchor box to contain a specific object.

For example, as the anchor-based model, there is the R-CNN series (R-CNN, Fast R-CNN, Faster R-CNN), and the first processing unit 121 may apply this model to detect objects based on the proposal regions in the image, and in particular, in Faster R-CNN, a region proposal network (RPN) may generate anchor boxes and detect objects based on the generated anchor boxes.

In addition, YOLO may be used as the anchor-based model, and the first processing unit 121 may apply the YOLO model to predict the presence of objects using multiple anchor boxes in each grid cell of the image.

In addition, a single shot multi-box detector (SSD) may be used as the anchor-based model, and the first processing unit 121 may detect objects of various sizes by applying this model using anchor boxes of various sizes.

The anchor-free model may be a model that directly predicts pixels or grid cells of an image without using anchor boxes to determine the position and size of an object. This approach has the advantage of reducing computational costs and reducing complexity due to anchor settings because it does not use anchor boxes.

For example, CornerNet may be used as the anchor-free model, and the first processing unit 121 may apply this model to detect each corner point of the image and form a bounding box of the object.

In addition, CenterNet may be used as the anchor-free model, and the first processing unit 121 may apply this model to detect an object based on a centroid and predict the size and offset of the object at each centroid.

In addition, fully convolutional one-stage object detection (FCOS) may be used as the anchor-free model, and the first processing unit 121 may apply this model to predict the centroid of the object at each pixel position and determine the size and position of the object.

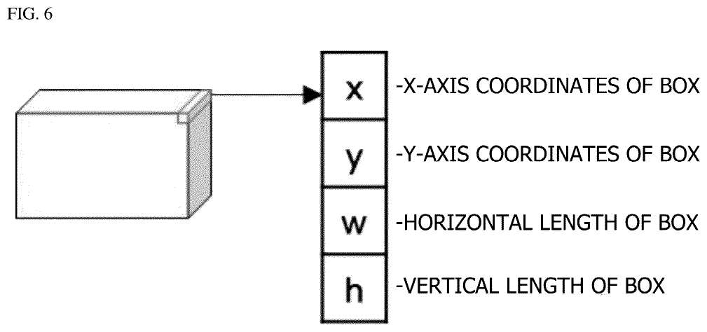

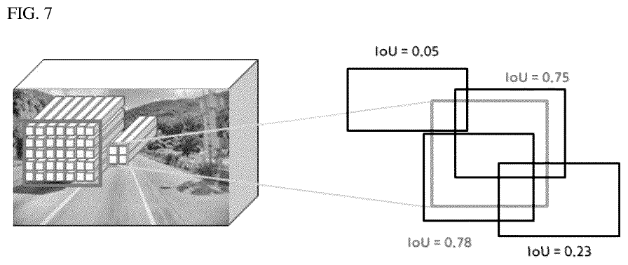

FIG. 7 shows an example of the operation of the first processing unit 121 according to an example. Referring to FIG. 7, the first processing unit 121 calculates the number of bounding boxes whose IoU value with a reference bounding box exceeds a specific criterion compared to the number of dimension vectors within the range, the reference bounding box being selected to finally define the position and dimension of the object among the bounding boxes determined by the dimension vectors. At this time, the first processing unit 121 may select the bounding box to include all dimension vectors that overlap even a little bit with the reference bounding box region.

In FIG. 7, an IoU specific criterion for an object corresponding to the small bounding box at the right side may be determined to 0.7, and the first processing unit 121 may select two bounding boxes that exceed the predetermined IoU value of 0.7 among the selected bounding boxes. The first processing unit 121 may calculate a position consistency index using the number of bounding boxes that exceed the IoU specific criterion compared to the total number of bounding boxes excluding the reference bounding box. The first processing unit 121 may calculate the position consistency index of the bounding box according to Equation 1 below.

$${P}_{i} = \frac{N}{M} \qquad [ Equation 1 ]$$

In Equation 1, Pi denotes a position consistency index of a bounding box for a specific object, M denotes the total number of bounding boxes for a specific object, and N denotes the number of bounding boxes exceeding a specific IoU criterion.

The first processing unit 121 may calculate the aforementioned bounding box consistency probability value for each object detected in the image, and calculate the smallest probability value among the calculated probability values as a second score as in Equation 2 below.

$${S}_{bb} = {min}_{i} {P}_{i} ( i : index of bounding box in a n image ) \qquad [ Equation 2 ]$$

In Equation 2, S_{bb} denotes a first score, and Pi denotes a position consistency index of the bounding box for each object.

The second processing unit 122 may calculate the second score by evaluating the class entropy of the object using class probability information of the object. The class entropy is a concept used to measure the entropy of class distribution in deep learning and machine learning, and may quantitatively evaluate how evenly the class labels of a dataset are distributed, mainly in classification issues. The class entropy may measure the uncertainty of class distribution in a specific data set. The higher the class entropy, the more even the class distribution is, and the lower the class entropy, the more data is concentrated in a specific class. The second processing unit 122 may calculate the second score using contribution for each class to the class inference uncertainty of a specific position in the image.

The class entropy of an object is a measure of the uncertainty in classifying the object based on the probabilities predicted by an object detection or classification model. It may quantify how confident the model is in assigning the object to a specific class by analyzing the distribution of predicted probabilities across all possible classes. High entropy indicates greater uncertainty, where the model assigns relatively equal probabilities to multiple classes (e.g., 33% car, 33% truck, 34% bike), suggesting that it is unsure about the object's class. In contrast, low entropy reflects higher confidence, where one class has a significantly higher probability (e.g., 90% car, 5% truck, 5% bike). Mathematically, class entropy may be calculated using Shannon's entropy formula, which sums the probabilities weighted by their logarithms. This metric is valuable for identifying objects or image regions where the model struggles, enabling targeted improvements in the training process. For instance, in active learning, high-entropy objects are prioritized for labeling and retraining, allowing a system to refine its ability to handle confusing or ambiguous classifications.

For example, the second processing unit 122 may calculate Shannon entropy as shown in Equation 3 below.

$${H}_{i , j} = - {\sum }_{k = 0} p ( {x}_{i , j , k} ) log p ( {x}_{i , j , k} ) ( i , j : x , y coordinate , k : class index ) \qquad [ Equation 3 ]$$

In Equation 3, H_{i,j} denotes a Shannon entropy value for class inference at i, j position in an image, and p(x_{i,j,k}) may denote the probability that an object at the i, j position in the image has class k. As a result, Equation 3 may mean that the more uniform the distribution, the higher the entropy H, and the more non-uniform the distribution, the lower the entropy H. In other words, the amount of information and entropy for the uniform distribution increases because the degree of entropy is large.

For example, the second processing unit 122 may calculate the contribution for each class to the class inference uncertainty at a specific position in the image according to Equation 4 below.

$${C}_{i , j , k} = \frac{p ( {x}_{i , j , k} )}{{p}_{max} ( {x}_{i , j} )} {H}_{i , j} ( W : width , H : height ) \qquad [ Equation 4 ]$$

In Equation 4, C_{i,j,k} denotes a contribution index for each class in inferring class k at the i, j position in the image, p(x_{i,j,k}) denotes the probability that the object at the i, j position in the image has class k, and μₘₐₓ(x_{i,j,k}) is the maximum class probability for the object at the i, j position in the image.

For example, the second processing unit 122 may calculate the second score according to Equation 5 below.

$${S}_{cls , k} = \frac{1}{N} {\sum }_{i = 0}^{W} {\sum }_{j = 0}^{H} \frac{p ( {x}_{i , j , k} )}{{p}_{max} ( {x}_{i , j} )} {H}_{i , j} {I}_{i , j} ( W : width , H : height ) , N = {\sum }_{i = 0}^{W} {\sum }_{j = 0}^{H} {I}_{i , j} , {I}_{i , j} = \begin{matrix}0 , if {p}_{max} ( {x}_{i , j )} \leq {P}_{threshold} \\ 1 , if {p}_{max} ( {x}_{i , j )} > {P}_{threshold}\end{matrix} \qquad [ Equation 5 ]$$

In Equation 5, S_{cls,k} denotes the second score obtained by evaluating the class entropy for class k in a specific image, p(x_{i,j,k}) denotes the probability that the object at the i, j position in the image has class k, ρₘₐₓ(x_{i,j,k}) denotes the maximum class probability for the object at the i, j position in the image, and H_{i,j} denotes a Shannon entropy value for class inference at the i, j position in the image.

At this time, the second processing unit 122 may perform filtering based on the maximum probability value so as not to reflect the fact that the maximum probability is low and the entropy is high in the case of meaningless pixels such as the background.

The third processing unit 123 may store the image and corresponding meta information in the database in at least one of cases where the first score is less than a predetermined first threshold value and where the second score exceeds a predetermined second threshold value. The first threshold value and the second threshold value are values transmitted from the training server 2 and may be updated according to retraining results as described below.

In an example, the meta information may include position and dimension information of the object, the first score, the class probability information of the object, and the second score.

The third processing unit 123 may store, if the first score is less than the predetermined first threshold, the corresponding image and corresponding meta information in the database. That is, if the consistency of the bounding box for a specific object in the image is less than the predetermined threshold value and thus the reliability for the bounding box decreases, the third processing unit 123 may store the corresponding image and corresponding meta information in the database.

Alternatively, the third processing unit 123 may store, if the second score exceeds the predetermined second threshold value, the corresponding image and corresponding meta information in the database. That is, the third processing unit 123 may store the corresponding image and corresponding meta information in the database if the uncertainty for a specific class in the image exceeds the predetermined threshold value and thus the reliability for the specific class classification decreases.

Alternatively, the third processing unit 123 may store, if the first score is less than the predetermined first threshold while the second score exceeds the predetermined second threshold value, the corresponding image and corresponding meta information in the database.

The third processing unit 123 may delete the images stored in the database if a critical number of images are selected among the stored images and transmitted to the training server 2 according to the control operation of the fourth processing unit 124.

In addition, when an image storage trigger signal is generated, the third processing unit 123 may store the image captured at the corresponding time period and the corresponding meta information in the database. When a specific trigger signal is generated according to the control operation of the vehicle regardless of the first score and the second score, the third processing unit 123 may store the image at the time when the trigger signal is generated, together with the meta information. Through this, it is possible to determine whether the consistency of the bounding box and the class entropy are generated by a vehicle control signal or by the object detection performance.

In addition, the third processing unit 123 may analyze the cause of the deterioration of the object detection performance using the meta information. For example, the third processing unit 123 may determine that there is a problem in the class classification performance if the Shannon entropy is higher than a predetermined threshold value, and determine that there is a problem in the localization performance of the bounding box if the second score is lower than the predetermined threshold value. Alternatively, the third processing unit 123 may analyze the cause of the deterioration of the object detection performance as confusion occurring in top n classes that show high values of the second score based on the value of the second score.

The fourth processing unit 124 may control the communication unit 110 to transmit the stored images and meta information to the training server 2. For example, the fourth processing unit 124 may transmit the stored images and meta information to the training server 2 according to a predetermined cycle. Alternatively, the fourth processing unit 124 may transmit the stored images and meta information to the training server 2 if the number of images stored in the database exceeds a reference value.

The fourth processing unit 124 may alternately select the image with the lowest first score and the image with the highest second score and transmit them to the training server 2 along with the corresponding meta information.

The fourth processing unit 124 may skip the image that has already been selected during the alternate selection and proceed with the next data selection process.

The fourth processing unit 124 may perform the alternate selection as many times as a predetermined threshold number.

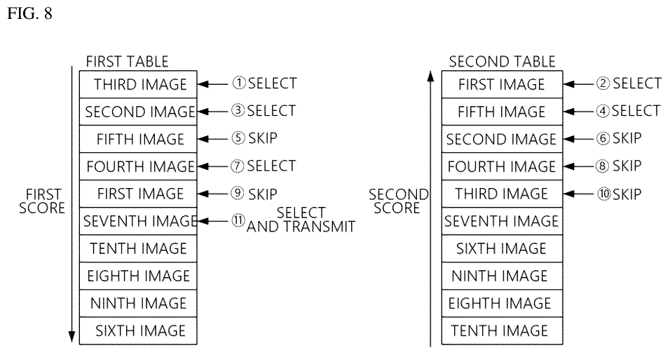

FIG. 8 shows an example of the operation of the fourth processing unit 124 according to an example. Referring to FIG. 8, a first table in which 10 images are sorted based on the first score and a second table in which 10 images are sorted based on the second score are classified.

In the first table, images are in ascending order with an image with the lowest first score at the top, and in the second table, images are sorted in descending order with an image with the highest second score at the top.

The fourth processing unit 124 may select images of the first table and the second table by alternately selecting one image from the top of the first table and then selecting one image from the top of the second table. The fourth processing unit 124 may alternately select images from each table from the top to the bottom.

The fourth processing unit 124 may store the selected image in a transmission target table. At this time, the fourth processing unit 124 does not re-select the images already stored in the transmission target table during the image selection process of a specific table, skips the image selection process, and proceeds to the image selection process in other tables. The fourth processing unit 124 may terminate the image selection process if 6 images are selected according to the predetermined threshold number and stored in the transmission target table. If the image selection process is completed, the fourth processing unit 124 may transmit a completion signal to the third processing unit 123, and the third processing unit 123 may delete the images stored in the database.

The transmission target table may store an identification signal of the image together. The fourth processing unit 124 may transmit the image and meta information corresponding to the transmission target table, to the training server 2 through the communication unit 110.

The training server 2 may perform evaluation of a training data set in the deep learning model. Evaluation of the training data set may mean a process of measuring how well the model generalizes what the model has learned, that is, how well the model performs on actual data. The evaluation process is mainly conducted for the purpose of verifying and improving the performance of the model, and various methods and indicators may be used for evaluating the training dataset.

The training server 2 may classify data into training data, validation data, and test data. The training data (training set) is data used to train the model, and the validation data (validation set) is data used to tune and verify the performance of the model and may be used for hyperparameter optimization and model selection. The test data (test set) is used to ultimately evaluate the performance of the model, and may be used to identify how well the model actually works.

The training server 2 may select a class with the lowest recognition performance as a target class using the training data, the validation data, and the test data. The training server 2 may select the target class using accuracy, which is the ratio of correct prediction data to all predictions, precision, which is the ratio of actually positive prediction data to positive predictions, recall, which is the ratio of correct prediction data among actual positive predictions, and F1 score, which is the harmonic average of the precision and the recall.

In addition, the training server 2 may set a first threshold value and a second threshold value using the criteria for selecting data of a certain ratio among the evaluation data. For example, the threshold values may be set so that about 10% of the images may be selected when filtering is performed based on the score among the training data to be evaluated. These threshold values may be adjusted according to the performance of the learning model, and may be set to satisfy the ratio of data to be used as the training data among the entire data according to various conditions such as the purpose of the learning model and the application environment.

The training server 2 may perform training using the image received from the training data selection device 100. The training data selection device 100 according to the example may perform an operation of selecting training data to implement active learning. The active learning is a methodology used to increase data efficiency in deep learning and machine learning. In general, a large amount of labeled data is required in the training process of a learning model, but labeling a large amount of data may cost and time-consuming. Therefore, the training data selection device 100 according to the example may select data points that are expected to be most useful for training during training of the training server 2 to perform labeling, and perform an operation of selecting the labeled data.

The training server 2 may first train an initial model with a small amount of labeled data. The training server 2 may select data points that require labeling using the trained model. In this process, the evaluation process of the training data set described above may be applied, and generally, data points with high uncertainty may be selected.

The training server 2 may request data selection by transmitting the selected data points to the training data selection device 100 according to the example.

The training server 2 may retrain the model using the image and meta information received from the training data selection device 100.

The training server 2 may gradually improve the model performance by repeatedly performing the evaluation process and training process described above.

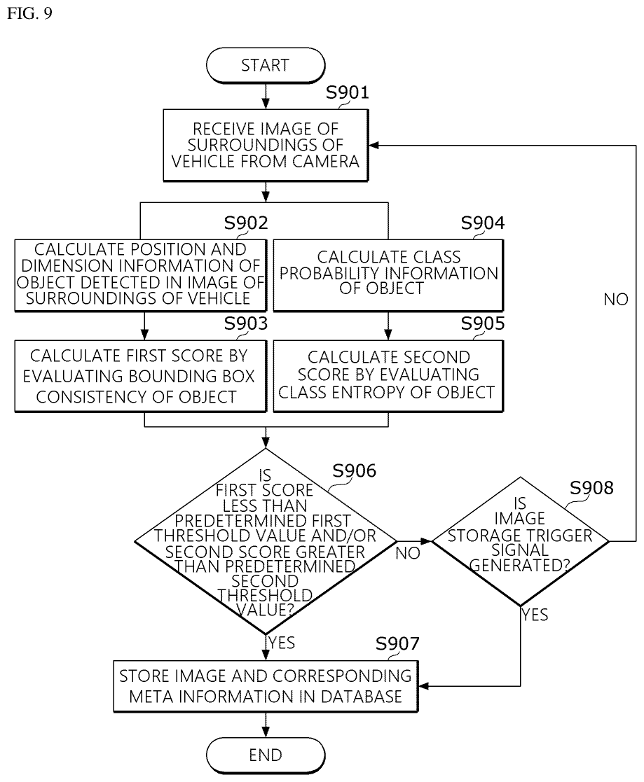

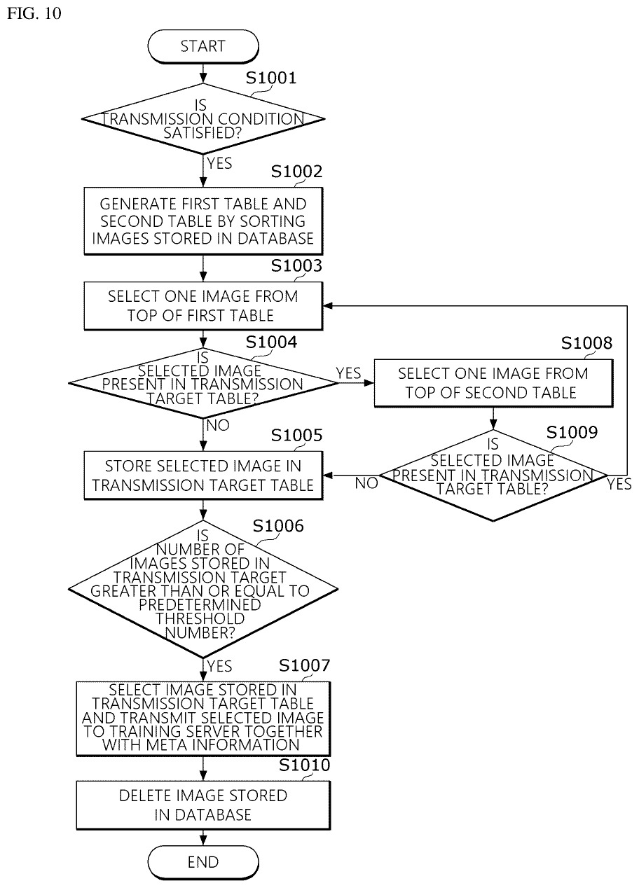

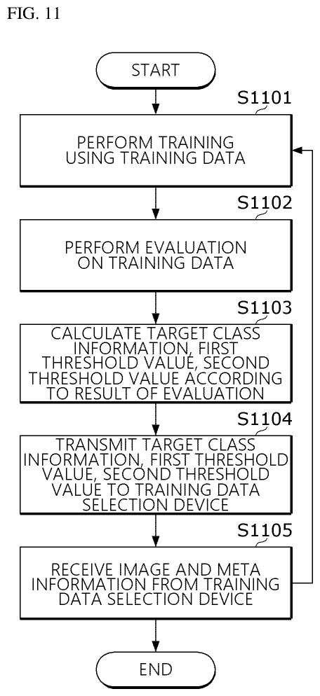

For convenience, FIG. 9, FIG. 10, and FIG. 11 are described by way of an example in which the steps are performed by a processor (e.g., control circuitry). One, some, or all steps of FIG. 9, FIG. 10, and FIG. 11, or portions thereof, may be performed by one or more other circuits. One or some, steps of FIG. 9, FIG. 10, and FIG. 11 may be omitted, performed in other orders, and/or otherwise modified, and/or one or more additional steps may be added.

FIG. 9 shows an example of a training data selection method according to an example. Referring to FIG. 9, first, the communication unit receives an image of the surroundings of a vehicle from a camera in operation S901.

Next, the first processing unit calculates position and dimension information of an object detected from the image of the surroundings of the vehicle in operation S902.

Next, the first processing unit calculates a first score by evaluating the bounding box consistency of the object using the position and dimension information of the object in operation S903.

The second processing unit calculates class probability information of the object in operation S904.

Next, the second processing unit calculates the second score by evaluating the class entropy of the object using the class probability information of the object in operation S905.

The first score calculation operation of the first processing unit and the second score calculation operation of the second processing unit may be performed simultaneously, or one score calculation operation may be performed before the other score calculation operation.

Next, the third processing unit stores the image and the corresponding meta information in the database in at least one of the case where the first score is less than a predetermined first threshold value and case where the second score exceeds a predetermined second threshold value in operations S906 and 907.

Alternatively, when an image storage trigger signal is generated, the third processing unit stores the image captured during the corresponding time period and the corresponding metadata in the database. At this time, the third processing unit does not perform a comparison process between the score and the threshold value, but directly stores the image corresponding to the trigger signal generation time in the database in operation S908.

FIG. 10 shows an example of a training data selection method according to an example. Referring to FIG. 10, first, the fourth processing unit determines whether the transmission condition of image data is satisfied in operation S1001.

The fourth processing unit organizes the images stored in the database to generate a first table and a second table. The fourth processing unit generates the first table by sorting images in ascending order with an image with the lowest first score at the top and the second table by sorting images in descending order with an image with the highest second score at the top in operation S1002.

The fourth processing unit selects one image from the top of the first table and stores the selected image in the transmission target table. At this time, the fourth processing unit does not reselect the images already stored in the transmission target table, skips the image selection process, and proceeds to the selection process in the other table. The fourth processing unit changes a selection window to the following order so that the images once selected in each table are not selected again, in operations S1003 to 1005.

Next, the fourth processing unit determines whether the number of images stored in the transmission target table is greater than or equal to a predetermined threshold number in operation S1006.

If the number of images stored in the transmission target table is less than the predetermined threshold number, the fourth processing unit selects one image from the top of the second table and stores the selected image in the transmission target table. At this time, the fourth processing unit does not re-select the images already stored in the transmission target table, skips the image selection process, and proceeds to the selection process in the other table. The fourth processing unit changes the selection window to the following order so that the images that have been selected once in each table are not selected again, in operations S1008 and 1009.

Next, the fourth processing unit determines whether the number of images stored in the transmission target table is greater than or equal to a predetermined threshold number in operation S1006.

If the number of images stored in the transmission target table is less than or equal to the predetermined threshold number, the fourth processing unit repeats the process of selecting images from the first table in operations S1003 to 1005.

If the number of images stored in the transmission target table is greater than or equal to the predetermined threshold number, the fourth processing unit selects the image stored in the transmission target table and transmits the selected image to the training server together with the meta information in operation S1007.

In addition, if the image selection process is completed, the fourth processing unit transmits a completion signal to the third processing unit. The third processing unit, which receives the completion signal, deletes the image stored in the database in operation S1010.

FIG. 11 shows an example of a training data selection method according to an example. Referring to FIG. 11, the training server performs training using training data. At this time, the training data may include images and meta information received from the training data selection device in operation S1101.

Next, the training server performs an evaluation on the training data in operation S1102.

Next, the training server calculates target class information, a first threshold value, and a second threshold value based on the evaluation result in operation S1103.

Next, the training server transmits the target class information, the first threshold value, and the second threshold value to the training data selection device in operation S1104.

Next, the training server receives images and meta information from the training data selection device in operation S1105.

The training server repeats the re-training and training data evaluation process using the images and meta information from the training data selection device.

In this manner, the training server may transmit the target class information, the first threshold value, and the second threshold value generated through the evaluation process to the training data selection device, and repeat re-training processes using the images and meta information received from the training data selection device, thereby gradually improving the performance of the model.

The present disclosure is directed to providing a training data selection device and method which may determine whether to collect data by identifying a class being a cause of uncertainty of class inference from an image with high uncertainty.

The present disclosure is also directed to providing a training data selection device and method which may model the inference uncertainty with respect to the position and size of the bounding box of an object and utilize the modeled inference uncertainty for selecting training data.

Through this, the present disclosure is also directed to providing a training data selection device and method which may efficiently operate the pipeline of active learning.

According to an example of the present disclosure, there is provided a training data selection device including: a communication unit configured to perform communication with a training server; a first processing unit configured to calculate a first score, using position and dimension information of an object detected in an image of surroundings of a vehicle, by evaluating consistency of a bounding box of the object; a second processing unit configured to calculate a second score by evaluating class entropy of the object using class probability information of the object; a third processing unit configured to store the image and corresponding meta information in a database in at least one of cases where the first score is less than a predetermined first threshold value and where the second score exceeds a predetermined second threshold value; and a fourth processing unit configured to transmit the stored image and meta information to the training server by controlling the communication unit.

The fourth processing unit may alternately select an image with the lowest first score and an image with the highest second score and transmit the selected images to the training server along with the corresponding meta information.

The fourth processing unit may skip the image that has already been selected during the alternate selection and proceed with the next data selection process.

The fourth processing unit may perform the alternate selection as many times as a predetermined threshold number.

The third processing unit may delete the image stored in the database if the images selected as many as the threshold number are transmitted to the training server.

The communication unit may receive target class information, the first threshold value, and the second threshold value from the training server.

The meta information may include the position and dimension information of the object, the first score, the class probability information of the object, and the second score.

The first processing unit may calculate the first score using consistency between dimension vectors included in the bounding box.

The second processing unit may calculate the second score using contribution for each class to class inference uncertainty of a specific position in the image.

The third processing unit may store, if an image storage trigger signal is generated, an image captured during the corresponding time period and the corresponding meta information in the database.

According to another example of the present disclosure, there is provided a training data selection method including: calculating, by a first processing unit, position and dimension information of an object detected in an image of surroundings of a vehicle; calculating, by the first processing unit, a first score by evaluating bounding box consistency of the object using the position and dimension information of the object; calculating, by a second processing unit, class probability information of the object; calculating, by a second processing unit, a second score by evaluating class entropy of the object using the class probability information of the object; storing, by a third processing unit, the image and corresponding meta information in a database in at least one of cases where the first score is less than a predetermined first threshold value and where the second score exceeds a predetermined second threshold value; and transmitting, by a fourth processing unit, the stored image and meta information to a training server by controlling a communication unit.

The transmitting of the stored image and meta information to the training server may include alternately selecting an image with the lowest first score and an image with the highest second score, and transmitting the selected images to the training server along with the corresponding meta information.

The transmitting of the stored image and meta information to the training server may include skipping the image that has already been selected during the alternate selection and proceeding with the next data selection process.

The transmitting of the stored image and meta information to the training server may include performing the alternately selecting as many times as a predetermined threshold number, and transmitting the image and meta information to the training server.

The training data selection method may further include deleting, by the third processing unit, the image stored in the database if the images selected as many as the threshold number are transmitted to the training server.

Before the calculating of the position and dimension information of the object, the training data selection method may further include receiving, by the communication unit, target class information, the first threshold value, and the second threshold value from the training server.

The training data selection method may further include evaluating, by the training server, training data; and calculating, by the training server, the target class information, the first threshold value, and the second threshold value according to a result of the evaluating.

The training data selection method may further include performing, by the training server, training using the image and meta information received by the communication unit as training data; evaluating, by the training server, the training data; calculating, by the training server, target class information, the first threshold value, and the second threshold value according to the result of evaluating; and transmitting, by the training server, the target class information, the first threshold value, and the second threshold value to the communication unit.

The calculating of the first score may include calculating the first score using the consistency between dimension vectors included in the bounding box.

The calculating of the second score may include calculating the second score using contribution for each class to class inference uncertainty of a specific position in the image.

The training data selection method may further include storing, by the third processing unit, an image captured during the corresponding time period and the corresponding meta information in the database if an image storage trigger signal is generated.

The term “unit” or the like used herein may refer to a software or hardware component, such as a field-programmable gate array (FPGA) or an application-specific integrated circuit (ASIC), and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

As described above, the training data selection device and method according to the example may determine the inference uncertainty of the data object recognition model under more detailed conditions.

In addition, the data collection policy for classes with relatively weak detection performance may be automated.

In addition, the abnormal detection situation of the recognition module may be analyzed when an event occurs on the vehicle control signal.

Although the present disclosure has been described above with reference to preferred examples thereof, it will be understood by those skilled in the art that various modifications and changes may be made to the present disclosure without departing from the spirit and scope of the present disclosure as set forth in the claims below.

What is claimed is:

1. An apparatus for controlling autonomous driving of a vehicle, the apparatus comprising:
a processor;
a communication circuit configured to perform communication with a training server;
a memory storing instructions that, when executed by the processor, are configured to cause the apparatus to:
obtain a first score by determining consistency of a bounding box of an object, wherein the object is detected in an image and is within a threshold distance from the vehicle, and wherein the determining the consistency is based on position and dimension information of the object;
obtain a second score by determining class entropy of the object based on class probability information of the object;
store the image and corresponding meta information in a database based on at least one of:
the first score being less than a predetermined first threshold value, or
the second score exceeding a predetermined second threshold value;
transmit, via the communication circuit, the stored image and corresponding meta information to the training server;
receive updated information from the training server based on the stored image and corresponding meta information;
output, based on the updated information, a signal; and
control, based on the signal, autonomous driving of the vehicle.

2. The apparatus of claim 1, wherein the instructions, when executed by the processor, are further configured to cause the apparatus to:
alternately select a first image with a lowest first score and a second image with a highest second score, wherein the lowest first score is a lowest score among first scores associated with consistency of the bounding box, and wherein the highest second score is a highest score among second scores associated with class entropy of the object; and
transmit the selected first and second images to the training server along with the corresponding meta information.

3. The apparatus of claim 2, wherein the instructions, when executed by the processor, are further configured to cause the apparatus to skip an image that has already been selected during the alternate selection and proceed with a next selection process.

4. The apparatus of claim 2, wherein the alternate selection is performed as many times as a predetermined threshold number.

5. The apparatus of claim 4, wherein the instructions, when executed by the processor, are further configured to cause the apparatus to delete images stored in the database based on the images being selected as many as the predetermined threshold number and transmitted to the training server.

6. The apparatus of claim 1, wherein the instructions, when executed by the processor, are further configured to cause the apparatus to receive, from the training server, target class information, the predetermined first threshold value, and the predetermined second threshold value.

7. The apparatus of claim 1, wherein the corresponding meta information comprises the position and dimension information of the object, the first score, the class probability information of the object, and the second score.

8. The apparatus of claim 1, wherein the instructions, when executed by the processor, are further configured to cause the apparatus to obtain the first score based on consistency among dimension vectors included in the bounding box.

9. The apparatus of claim 1, wherein the instructions, when executed by the processor, are further configured to cause the apparatus to obtain the second score based on contribution of each class to class inference uncertainty at a specific position in the image.

10. The apparatus of claim 1, wherein the instructions, when executed by the processor, are further configured to cause the apparatus to store, in the database and based on receiving an image storage trigger signal, an image and meta information associated with the image, wherein the image is captured during a time period associated with the image storage trigger signal.

11. A method performed by an apparatus for controlling autonomous driving of a vehicle, the method comprising:
determining position and dimension information of an object detected in an image, wherein the object is within a threshold distance from the vehicle;
obtaining a first score by determining consistency of a bounding box of the object based on the position and dimension information of the object;
determining class probability information of the object;
obtaining a second score by determining class entropy of the object based on the class probability information of the object;
storing the image and corresponding meta information in a database based on at least one of:
the first score being less than a predetermined first threshold value, or
the second score exceeding a predetermined second threshold value;
transmitting, via a communication circuit of the vehicle, the stored image and corresponding meta information to a training server;
receiving updated information from the training server based on the stored image and corresponding meta information;
outputting, based on the updated information, a signal; and
controlling, based on the signal, autonomous driving of the vehicle.

12. The method of claim 11, wherein the transmitting the stored image and corresponding meta information comprises:
alternately selecting a first image with a lowest first score and a second image with a highest second score, wherein the lowest first score is a lowest score among first scores associated with consistency of the bounding box, and wherein the highest second score is a highest score among second scores associated with class entropy of the object; and
transmitting the selected first and second images to the training server along with the corresponding meta information.

13. The method of claim 12, wherein the transmitting the stored image and corresponding meta information comprises: skipping an image that has already been selected during the alternately selecting and proceeding with a next data selection process.

14. The method of claim 12, wherein the transmitting the stored image and corresponding meta information comprises performing the alternately selecting as many times as a predetermined threshold number, and transmitting the selected first and second images along with the corresponding meta information to the training server.

15. The method of claim 14, further comprising
deleting images stored in the database based on the images being selected as many as the predetermined threshold number and transmitted to the training server.

16. The method of claim 11, further comprising:
before the determining the position and dimension information of the object,
receiving, from the training server and via the communication circuit, target class information, the predetermined first threshold value, and the predetermined second threshold value.

17. The method of claim 16, further comprising:
causing the training server to perform:
a training process based on the image and corresponding meta information received via the communication circuit as training data;
determining, based on the training data, target class information, the predetermined first threshold value, and the predetermined second threshold value; and
transmitting the target class information, the first predetermined threshold value, and the predetermined second threshold value to the vehicle via the communication circuit.

18. The method of claim 11, wherein the obtaining the first score comprises obtaining the first score based on consistency among dimension vectors included in the bounding box.

19. The method of claim 11, wherein the obtaining the second score comprises obtaining the second score based on contribution of each class to class inference uncertainty at a specific position in the image.

20. The method of claim 11, further comprising:
storing, in the database and based on receiving an image storage trigger signal, an image and meta information associated with the image, wherein the image is captured during a time period associated with the image storage trigger signal.
